(19) United States
(12) Patent Application Publication
(10) Pub. No.: US 2019/0194480 A1
(43) Pub. Date: Jun. 27, 2019

(54) WEATHER RESISTANCE IMPROVER, WEATHER RESISTANCE IMPROVER-CONTAINING RESIN COMPOSITION FOR COATING METAL NANOWIRE-CONTAINING LAYERS, AND METAL NANOWIRE-CONTAINING LAMINATE

(71) Applicant: SEIKO PMC CORPORATION, Tokyo (JP)

(72) Inventors: Toshiyuki HASEGAWA, Chiba (JP); Munetoshi KURIMURA, Chiba (JP); Aya SAKATOKU, Chiba (JP); Naoto IKEDA, Chiba (JP); Tomoaki KAWAGUCHI, Chiba (JP)

(21) Appl. No.: 16/308,861

(22) PCT Filed: Jun. 27, 2017
(86) PCT No.: PCT/JP2017/023523

§ 371 Date: Dec. 11, 2018

(30) Foreign Application Priority Data
Jul. 5, 2016 (JP) 2016-133313

(51) Int. Cl. C09D 7/48; C09D 7/63

(52) U.S. Cl. CPC C09D 7/48; C09D 7/63

(57) ABSTRACT

The present invention relates to a weather resistance improver including a compound (A) and at least one of a compound (B) and a compound (C), in which the compound (A) is a compound represented by general formula (1) or (2) below, the compound (B) is gallic acid, a gallic acid derivative or tannic acid, and the compound (C) is a compound represented by general formula (3) below. Such a weather resistance improver can suppress degradation of a transparent conductive film including a metal nanowire both under long-term exposure to sunlight and under high humidity and high temperature conditions.

### TECHNICAL FIELD

The present invention relates to a weather resistance improver, and particularly a weather resistance improver which can be used in a transparent conductive film including metal nanowires thereby to improve the weather resistance. The present invention further relates to: a resin composition for coating metal nanowire-containing layers which contain the weather resistance improver according to the present invention; and a metal nanowire-containing laminate.

### BACKGROUND ART

In recent years, display devices such as liquid crystal displays, plasma displays, organic electroluminescence displays, and electronic paper displays, sensors such as touch panels, and sunlight utilizing solar cells such as thin film-type amorphous Si solar cells and pigment-sensitized solar cells are increasingly used. Consequently, demands for transparent conductive films as a member essential to these devices are also increasing.

Since the diameter of metal nanowires is as small as nano-order, metal nanowires are high in the optical transparency in the visible light region, and expected to be applied as a transparent conductive film in place of ITO (indium tin oxide). Especially, a highly conductive silver nanowire-containing transparent conductive film has been proposed (for example, see Patent Documents 1, 2, and 3).

Since a transparent conductive film is applied to, for example, the above-described liquid crystal displays and input sensors such as touch panels, it is estimated to be also used under sunlight for a long term and under high humidity and high temperature conditions, both indoors and outdoors. A transparent conductive film including metal nanowires is required to simultaneously have two stabilities: light stability of maintaining a surface electrical resistance value under conditions of long-term exposure to sunlight, and high temperature and high humidity stability of maintaining a surface electrical resistance value under high temperature and high humidity conditions. On the other hand, since metal nanowires tend to lose electrical conductivity under both environments, a weather resistance improver is required for expressing the light stability and the high temperature and high humidity stability in combination.

Also, in the transparent conductive film including metal nanowires, the light stability is necessary not only in an irradiated portion which is to be exposed to sunlight but also in a boundary portion which is between the irradiated portion and a light blocked portion where sunlight is blocked by a shield. It is reported that electrical conductivity can particularly deteriorate at this boundary portion (for example, see Patent Documents 4 and 5). Patent Document 4 discloses a transition metal salt and a transition metal complex as a light stabilizer which is effective at the boundary portion, and Patent Document 5 discloses a metal particle, a metal oxide particle, and a metal complex compound as a light stabilizer which is effective at the boundary portion. However, there is no clear description regarding the high temperature and high humidity stability. Furthermore, a compound containing these metals has problems of coloring, promotion of the gelation of a polymerizable monomer and macromonomer which are simultaneously used, and deposition and transition. Therefore, it is considered that a weather resistance improver by an organic compound is preferable.

### CITATION LIST

### Patent Document

### Patent Document 1: JP-A-9-324324

### Patent Document 2: JP-A-2005-317395

### Patent Document 3: U.S. Published Patent Application No. 2007/0074316

### Patent Document 4: U.S. Published Patent Application No. 2015/0270024

### Patent Document 5: JP-A-2016-1608

### DISCLOSURE OF THE INVENTION

### Problems to be Solved by the Invention

The present invention is to provide a weather resistance improver for suppressing the degradation of a transparent conductive film including metal nanowires both under long-term exposure to sunlight and under high humidity and high temperature conditions.

### Solutions to the Problems

The present inventors intensively conducted studies for solving the above-described problems. As a result, it was found that the degradation of a transparent conductive film including metal nanowires both under long-term exposure to sunlight and under high humidity and high temperature conditions is suppressed with a weather resistance improver including a combination of specific compounds. Thus, the present invention has been accomplished.

That is, the present invention is as follows.

(i) A weather resistance improver including a compound (A) and at least one of a compound (B) and a compound (C).
Compound (A): a compound represented by general formula (1) or (2)

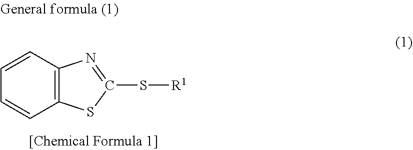

In general formula (1), R¹ represents a hydrogen atom, an alkyl group of 1 to 12 carbon atoms, or a (di)carboxyalkyl group having an alkyl group of 1 to 3 carbon atoms.

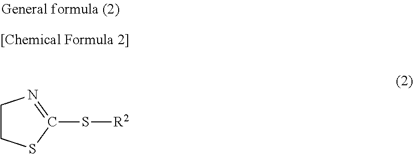

In general formula (2). R² represents a hydrogen atom, an alkyl group of 1 to 12 carbon atoms, or a (di)carboxyalkyl group having an alkyl group of 1 to 3 carbon atoms.
Compound (B): gallic acid, a gallic acid derivative, or tannic acid
Compound (C): a compound represented by general formula (3) below

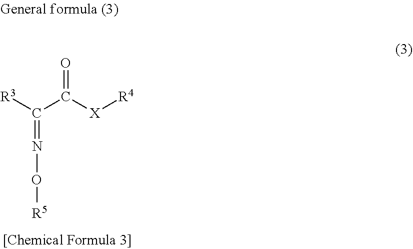

In general formula (3), X represents an oxygen atom or a sulfur atom, R³ represents a hydrogen atom, an acetyl group, a pyrazole group, or an aminothiazolyl group. R represents an alkyl group of 1 to 4 carbon atoms, or a benzothiazolyl group, and R⁵ represents an alkyl group of 1 to 4 carbon atoms, or an isobutyric acid alkyl ester group having an alkyl group of 1 to 4 carbon atoms.
(ii) The weather resistance improver according to the above-described (i), in which a ratio of a mass of the compound (A) to a total mass of the compound (B) and the compound (C) is 1/80≤the compound (A)/[compound (B)+compound (C)]≤80/1.
(iii) The weather resistance improver according to the above-described (i) or (ii), which is used for metal nanowires.
(iv) The weather resistance improver according to any one of the above-described (i) to (iii), in which the metal nanowires are silver nanowires.
(v) The weather resistance improver according to any one of the above-described (i) to (iv), in which the compound (A) is at least one selected from 2-mercaptothiazoline, 3-(2-benzothiazole-2-ylthio)propionic acid, and (1,3-benzothiazole-2-ylthio)succinic acid.
(vi) The weather resistance improver according to any one of the above-described (i) to (v), in which the compound (B) is tannic acid.
(vii) The weather resistance improver according to any one of the above-described (i) to (vi), in which the compound (C) is (Z)-2-(2-amino-4-thiazolyl)-2-(methoxyimino)thioacetic acid S-(2-benzothiazolyl).
(viii) A resin composition for coating metal nanowire-containing layers, including the weather resistance improver according to any one of the above-described (iii) to (vii), at least one of a photopolymerization initiator and a thermal polymerization initiator, and at least one of a polymerizable monomer and macromonomer.
(ix) A metal nanowire-containing laminate including a metal nanowire-containing layer and a protective layer for protecting the metal nanowire-containing layer disposed on the metal nanowire-containing layer, in which the protective layer is a cured product of the resin composition for coating metal nanowire-containing layers according to the above-described (viii).
(x) The metal nanowire-containing laminate according to the above-described (ix), in which the metal nanowire-containing layer contains the weather resistance improver according to any one of the above-described (i) to (vii).
(xi) The metal nanowire-containing laminate according to the above-described (ix) or (x), in which the metal nanowire-containing layer contains aqueous polyester resin.

### Effects of the Invention

According to the present invention, there is provided the weather resistance improver which can suppress the degradation of a transparent conductive film including metal nanowires both under long-term exposure to sunlight and under high humidity and high temperature conditions.

### BRIEF DESCRIPTION OF THE DRAWINGS

FIG. 1 is a schematic cross-sectional diagram illustrating an embodiment of a metal nanowire-containing laminate.

FIG. 2 is a schematic cross-sectional diagram illustrating another embodiment of a metal nanowire-containing laminate.

### DESCRIPTION OF PREFERRED EMBODIMENTS

Hereinafter, the present invention will be described in detail.

### [Weather Resistance Improver]

The weather resistance improver according to the present invention includes a compound (A) and at least one of a compound (B) and a compound (C). The use of a combination of the compound (A) and at least one of the compound (B) and the compound (C) is required for suppressing the degradation of metal nanowires both under long-term exposure to sunlight and under high temperature and high humidity conditions. This effect is not sufficient when the compound (A) or at least one of the compound (B) and the compound (C) is used alone.

### [Compound (A)]

The compound (A) is a compound represented by general formula (1) or (2) below. One of these may be used, or two or more thereof may be used in combination.

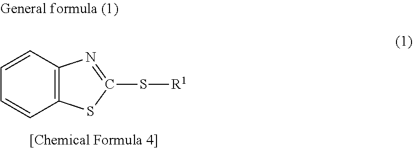

In general formula (1), R¹ represents a hydrogen atom, an alkyl group of 1 to 12 carbon atoms, or a (di)carboxyalkyl group having an alkyl group of 1 to 3 carbon atoms.

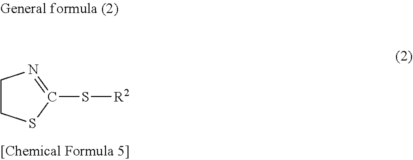

In general formula (2), R² represents a hydrogen atom, an alkyl group of 1 to 12 carbon atoms, or a (di)carboxyalkyl group having an alkyl group of 1 to 3 carbon atoms.

Examples of the alkyl group of 1 to 12 carbon atoms of R¹ or R² may include a methyl group, an ethyl group, an n-propyl group, an isopropyl group, an n-butyl group, an isobutyl group, a sec-butyl group, a tert-butyl group, an isoamyl group, a hexyl group, an octyl group, and a dodecyl group. Examples of the (di)carboxyalkyl group having an alkyl group of 1 to 3 carbon atoms of R¹ or R² may include a carboxymethyl group, a 1-carboxyethyl group, a 2-carboxyethyl group, a 1,2-dicarboxyethyl group, a 3-carboxypropyl group, and a 1,3-dicarboxypropyl group.

Specific examples of the compound (A) may include 2-mercaptothiazoline, 2-mercaptothiazoline methyl ether, 2-mercaptobenzothiazole, 2-mercaptobenzothiazole methyl ether, 2-mercaptobenzothiazole ethyl ether, 2-mercaptobenzothiazole propyl ether, 2-mercaptobenzothiazole butyl ether, 2-mercaptobenzothiazole isobutyl ether, 2-mercaptobenzothiazole dodecyl ether, (1,3-benzothiazole-2-ylthio)acetic acid, 2-(1,3-benzothiazole-2-ylthio)propionic acid, 3-(1,3-benzothiazole-2-ylthio)propionic acid, and (1,3-benzothiazole-2-ylthio)succinic acid.

Among these, from the viewpoint of weather resistance, the compound (A) is preferably 2-mercaptothiazoline, 2-mercaptobenzothiazole, 2-mercaptobenzothiazole methyl ether, 3-(1,3-benzothiazole-2-ylthio)propionic acid, and (1,3-benzothiazole-2-ylthio)succinic acid, particularly preferably 2-mercaptothiazoline, 3-(1,3-benzothiazole-2-ylthio)propionic acid, and (1,3-benzothiazole-2-ylthio)succinic acid. One of these may be used, or two or more thereof may be used in combination.

### [Compound (B)]

The compound (B) is gallic acid, a gallic acid derivative, or tannic acid. One of these may be used, or two or more thereof may be used in combination.

The gallic acid may be a gallic acid chemically synthesized by a known method, or may be a gallic acid isolated from leguminous plants, anacardiaceae plants, and the like. Also, the gallic acid may be a gallic acid chemically synthesized from the gallic acid isolated from these plants, or an extract containing the gallic acid obtained from these plants as it is. Also, a commercially available product can be used as the gallic acid.

An example of the gallic acid derivative may include gallic acid ester. A gallic acid alkyl ester containing an alkyl group of 1 to 20 carbon atoms within a molecule is generally known. The gallic acid derivative may be a gallic acid derivative chemically synthesized by a known method, or may be a gallic acid derivative isolated from plants such as Chinese gall. Also, the gallic acid derivative may be a gallic acid chemically synthesized from the gallic acid isolated from plants such as Chinese gall, or an extract containing the gallic acid obtained from plants such as Chinese gall as it is. Also, a commercially available product can be used as the gallic acid derivative.

The tannic acid is not particularly limited as long as it is a compound having a polyphenol (tannin) skeleton, and a tannic acid derived from plants can be used. From the viewpoint of weather resistance, a tannic acid derived from Chinese gall or Aleppo gall is further preferable.

Specific examples of the compound (B) may include gallic acid, methyl gallate, ethyl gallate, propyl gallate, butyl gallate, isobutyl gallate, isoamyl gallate, octyl gallate, dodecyl gallate, hexadecyl gallate, stearyl gallate, and tannic acid. Among these, from the viewpoint of weather resistance, gallic acid, methyl gallate, ethyl gallate, propyl gallate, butyl gallate, isobutyl gallate, isoamyl gallate, octyl gallate, and tannic acid are preferable, and tannic acid is particularly preferable. One of these may be used, or two or more thereof may be used in combination.

### [Compound (C)]

The compound (C) is a compound represented by general formula (3) below. One of these may be used, or two or more thereof may be used in combination.

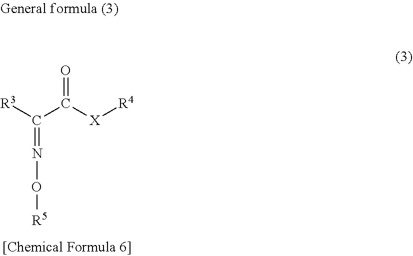

In general formula (3). X represents an oxygen atom or a sulfur atom, R³ represents a hydrogen atom, an acetyl group, a pyrazole group, or an aminothiazolyl group, R⁴ represents an alkyl group of 1 to 4 carbon atoms, or a benzothiazolyl group, and R⁵ represents an alkyl group of 1 to 4 carbon atoms, or an isobutyric acid alkyl ester group having an alkyl group of 1 to 4 carbon atoms.

Examples of the alkyl group of 1 to 4 carbon atoms of R⁴ and R⁵ may include a methyl group, an ethyl group, an n-propyl group, an isopropyl group, an n-butyl group, an isobutyl group, a sec-butyl group, and a tert-butyl group.

Specific examples of the compound (C) may include methoxyiminoacetic acid, (2Z)-[(2-ethoxy-2-oxoethoxy)imino]-(1H-pyrazole-5-yl)acetic acid, (Z)-2-(methoxyimino)-3-oxobutyric acid methyl ester, (Z)-2-(2-amino-4-thiazolyl)-2-(methoxyimino)ethyl acetate, (Z)-2-(2-amino-4-thiazolyl)-2-(methoxyimino)acetic acid, (Z)-2-(2-amino-4-thiazolyl)-2-(methoxyimino)thioacetic acid S-(2-benzothiazolyl), and (Z)-t-butyl 2-({[1-(2-aminothiazole-4-yl)-2-(benzo[d]thiazole-2-ylthio)-2-oxoethylidene]amino}oxy)-2-methylpropanoate.

Among these, from the viewpoint of weather resistance, (Z)-2-(2-amino-4-thiazolyl)-2-(methoxyimino) ethyl acetate, (Z)-2-(2-amino-4-thiazolyl)-2-(methoxyimino)thioacetic acid S-(2-benzothiazolyl), and (Z)-t-butyl 2-({[1-(2-aminothiazole-4-yl)-2-(benzo[d]thiazole-2-ylthio)-2-oxoethylidene]amino}oxy)-2-methylpropanoate are preferable, and (Z)-2-(2-amino-4-thiazolyl)-2-(methoxyimino)thioacetic acid S-(2-benzothiazolyl) is particularly preferable. One of these may be used, or two or more thereof may be used in combination.

In the present invention, the weather resistance improver is not necessarily a product obtained by previously mixing the compounds (A) to (C), as long as it is ultimately contained in a material of which the weather resistance is desired to be improved. The ratio of the mass of the compound (A) to the total mass of the compound (B) and the compound (C) is preferably 1/800≤compound (A)/[compound (B)+compound (C)]≤800/1, more preferably 1/80≤compound (A)/[compound (B)+compound (C)]≤80/1, further preferably 1/8≤compound (A)/[compound (B)+compound (C)]≤8/1.

### [Metal Nanowire-Containing Laminate]

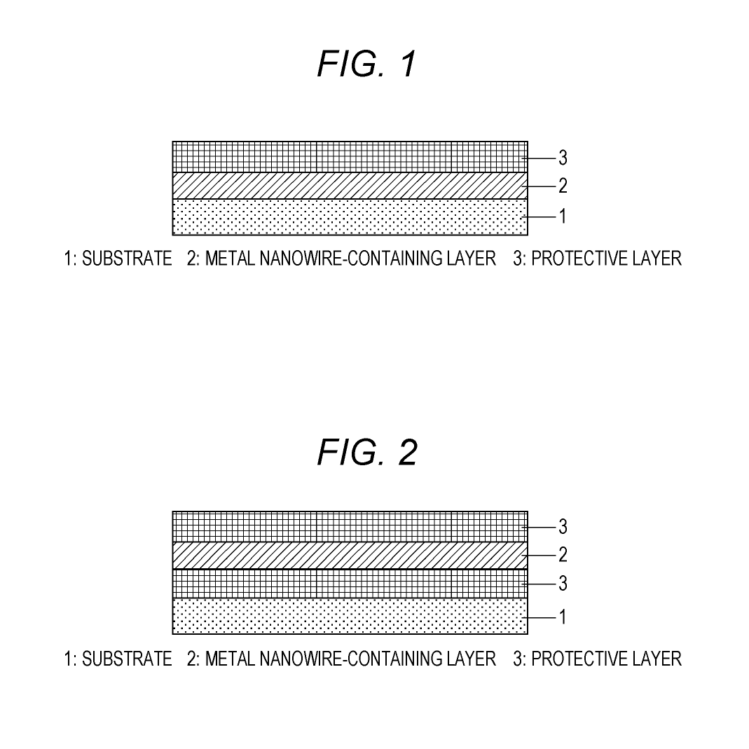

The metal nanowire-containing laminate is formed on a substrate. The metal nanowire-containing laminate is a laminate including: at least one metal nanowire-containing layer obtained by forming a film of a metal nanowire-containing composition; and at least one protective layer for protecting the metal nanowire-containing layer disposed on the metal nanowire-containing layer. The protective layer is obtained by forming a film of a resin composition for coating metal nanowire-containing layers. The position of the protective layer is not particularly limited, as long as the protective layer is disposed on the metal nanowire-containing layer. For example, the protective layer can be disposed on one or both of a first main surface side and a second main surface side of the metal nanowire-containing layer. Specifically, as illustrated in FIG. 1, a protective layer 3 can be disposed on a first main surface of a metal nanowire-containing layer 2 formed on a substrate 1. Also, as illustrated in FIG. 2, the protective layer 3 can be disposed on both of the first main surface and a second main surface of the metal nanowire-containing layer 2. From the viewpoint of protecting the metal nanowire-containing layer, the protective layer is preferably disposed on at least the first main surface of the metal nanowire-containing layer.

Although the protective layer is in contact with the metal nanowire-containing layer in the above-described examples, it may not be necessarily in contact with the metal nanowire-containing layer. Therefore, another layer may be disposed between the metal nanowire-containing layer and the protective layer.

The protective layer is preferably adjacent to the metal nanowire-containing layer, and more preferably in contact with the metal nanowire-containing layer. This is because the protective layer (weather resistance improver) moves to the metal nanowire layer to improve weather resistance.

### [Substrate]

The substrate may be appropriately selected depending on uses, and may be either hard or flexible. Also, the substrate may be colored. The substrate according to the present invention to be used is not particularly limited, as long as it is a substrate obtained by a known method or a commercially available substrate. Specific examples of a material of the substrate may include glass, polyimide, polycarbonate, polyethersulfone, polyacrylate, polyester, polyethylene terephthalate, polyethylene naphthalate, polyolefin, and polyvinyl chloride. An organic functional material and an inorganic functional material may be further formed to the substrate. Also, multiple substrates may be layered.

### [Metal Nanowire-Containing Composition]

The metal nanowire-containing composition is a composition which contains a metal nanowire, a binder, and a metal nanowire dispersion medium, and further contains, appropriately as necessary, a weather resistance improver and other additives described later.

### [Metal Nanowire]

The metal nanowire according to the present invention is a wire-like metal structure of a nano-level cross-sectional diameter having a cross-sectional diameter of less than 1 μm and an aspect ratio (major axis length/diameter) of 10 or more.

The diameter of the metal nanowire is preferably not less than 5 nm and less than 250 nm, more preferably not less than 10 nm and less than 150 nm.

The major axis length of the metal nanowire is preferably 0.5 μm or more and 500 μm or less, more preferably 2.5 μm or more and 100 μm or less.

The metal species of the metal nanowire is not particularly limited. Specific examples of the metal species may include gold, silver, copper, platinum, and alloys thereof. In consideration of performance, manufacturing easiness, costs, and the like, silver is comprehensively preferable. As the silver nanowire, a silver nanowire obtained by a known manufacturing method can be used. In the present invention, a silver nanowire obtained by a manufacturing method including a process of allowing a silver compound to react in polyol at 25 to 180° C. with an N-substituted acrylamide-containing polymer as a wire growth control agent is particularly preferable.

### [Binder]

Examples of the binder may include polysaccharides, aqueous polyester resin, aqueous polyurethane resin, aqueous acrylic resin, and aqueous epoxy resin. One of these resins may be used alone, or two or more thereof may be used in combination. Only polysaccharides or a combination of polysaccharides and aqueous polyester resin is preferable, and a combination of polysaccharides and aqueous polyester resin is further preferable.

### [Polysaccharides]

The polysaccharides refer to a polysaccharide and a derivative thereof. Specific examples of the polysaccharide may include starch, pullulan, guar gum, xanthan gum, cellulose, chitosan, and locust bean gum, as well as enzymatic decomposition products thereof. Also, specific examples of a derivative of a polysaccharide may include: a derivative of a partially etherified polysaccharide in which at least one of an alkyl group such as methyl, ethyl, and propyl, a hydroxyalkyl group such as hydroxyethyl, hydroxypropyl, and hydroxybutyl, a carboxyalkyl group such as carboxymethyl and carboxyethyl, and metal salts thereof is introduced to a polysaccharide; and a derivative of a polysaccharide or a derivative of a partially etherified polysaccharide obtained by graft polymerization of a polysaccharide or a derivative of a partially etherified polysaccharide with (meth)acrylic acid ester. Among these, a derivative of a partially etherified polysaccharide obtained by graft polymerization with (meth)acrylic acid ester is preferable, and hydroxypropyl methyl cellulose obtained by graft polymerization with (meth)acrylic acid ester is further preferable. One of these may be used, or two or more thereof may be used in combination.

### [Aqueous Polyester Resin]

The aqueous polyester resin may be any polyester resin as long as it can be dissolved or dispersed in an aqueous solvent or an aqueous dispersion medium. A specific example of the aqueous polyester resin may include a polycondensate between polyvalent carboxylic acid or an ester-forming derivative thereof and polyol or an ester-forming derivative thereof. Also, the aqueous polyester resin includes a derivative from the aqueous polyester resin. A specific example of the derivative of the aqueous polyester resin may include (meth)acrylic-modified aqueous polyester resin obtained by graft polymerization of aqueous polyester with (meth)acrylic acid ester. Among these, (meth)acrylic-modified aqueous polyester resin is preferable. One of these may be used, or two or more thereof may be used in combination.

The above-described polyvalent carboxylic acid is not particularly limited, as long as it is a compound having two or more carboxylic acid groups. Specific examples thereof may include: aromatic dicarboxylic acid such as phthalic acid, terephthalic acid, isophthalic acid, naphthalic acid, 1,2-naphthalenedicarboxylic acid, 1,4-naphthalenedicarboxylic acid, 1,5-naphthalenedicarboxylic acid or 2,6-naphthalenedicarboxylic acid, biphenyldicarboxylic acid, and orthophthalic acid; aliphatic dicarboxylic acid such as linear, branched, and alicyclic oxalic acid, malonic acid, succinic acid, glutaric acid, adipic acid, pimelic acid, 2,2-dimethylglutaric acid, suberic acid, azelaic acid, sebacic acid, dodecanedicarboxylic acid, 1,3-cyclopentanedicarboxylic acid, 1,4-cyclohexanedicarboxylic acid, and diglycolic acid; tricarboxylic acid such as trimellitic acid, trimesic acid, and pyromellitic acid; and metal sulfonate group-containing dicarboxylic acid and an alkali metal salt thereof such as sulfoterephthalic acid, 5-sulfoisophthalic acid, 4-sulfoisophthalic acid, 2-sulfoisophthalic acid, and 4-sulfonaphthalene-2,7-dicarboxylic acid. Examples of the ester-forming derivative of the polyvalent carboxylic acid may include derivatives such as an anhydride, ester, acid chloride, and halide of polyvalent carboxylic acid. One of these may be used, or two or more thereof may be used in combination.

The above-described polyol is not particularly limited, as long as it is a compound having two or more hydroxyl groups. Specific examples thereof may include ethylene glycol or diethylene glycol, trimethylol propane or glycerin, polyethylene glycol such as triethylene glycol, tetraethylene glycol, pentaethylene glycol, hexaethylene glycol, heptaethylene glycol, and octaethylene glycol, propylene glycol, polypropylene glycol such as dipropylene glycol, tripropylene glycol, and tetrapropylene glycol, 1,3-propanediol, 1,3-butanediol, 1,4-butanediol, 1,5-pentanediol, 1,6-hexanediol, 2,2-dimethyl-1,3-propanediol, 2-ethyl-2-butyl-1,3-propanediol, 2-ethyl-2-isobutyl-1,3-propanediol, 2,2,4-trimethyl-1,6-hexanediol, 1,2-cyclohexanedimethanol, 1,3-cyclohexanedimethanol, 1,4-cyclohexanedimethanol, and 2,2,4,4-tetramethyl-1,3-cyclobutanediol. An example of the ester-forming derivative of polyol may include a derivative in which a hydroxyl group of polyol is transformed into acetate. One of these may be used, or two or more thereof may be used in combination.

### [Aqueous Polyurethane Resin]

The aqueous polyurethane resin may be any polyurethane resin as long as it can be dissolved or dispersed in an aqueous solvent or an aqueous dispersion medium. A specific example of the aqueous polyurethane resin may include an aqueous polyurethane resin obtained by allowing diisocyanate and polyol to be subjected to polyaddition reaction, and further allowing the reaction product to be subjected to neutralization and chain elongation to become aqueous. One of these may be used, or two or more thereof may be used in combination.

### [Aqueous Acrylic Resin]

The aqueous acrylic resin may be any acrylic resin as long as it can be dissolved or dispersed in an aqueous solvent or an aqueous dispersion medium. Specific examples of the aqueous acrylic resin may include: anionic aqueous acrylic resin which is a copolymer between (meth)acrylic acid esters and an anionic polymerizable monomer; and cationic aqueous acrylic resin which is a copolymer between (meth)acrylic acid esters and a cationic polymerizable monomer. One of these may be used, or two or more thereof may be used in combination.

### [Aqueous Epoxy Resin]

The aqueous epoxy resin may be any epoxy resin as long as it can be dissolved or dispersed in an aqueous solvent or an aqueous dispersion medium. A specific example of the aqueous epoxy resin may include an aqueous epoxy resin obtained by allowing an epoxy group in any one of the following a) to c) raw material resins to react with an amine compound, and neutralizing a part of an introduced amine group with acid to become water-soluble or water-dispersible: a) a bisphenol-type epoxy oligomer; b) modified epoxy resin obtained by the reaction between a bisphenol-type epoxy oligomer and any of fatty acid or a derivative thereof, fatty acid amide, and unsaturated group-containing amines; and c) modified epoxy resin obtained by the reaction of a mixture of a bisphenol-type epoxy oligomer and polyalkyleneglycol diglycidyl ether with bisphenol A. One of these may be used, or two or more thereof may be used in combination.

### [Metal Nanowire Dispersion Medium]

The metal nanowire-containing composition includes a metal nanowire dispersion medium. The metal nanowire dispersion medium is not particularly limited, as long as it is a compound which allows for the dispersion of a metal nanowire and the dissolution of other components in the metal nanowire-containing composition and evaporates during film formation thereby to form a uniform coating. Examples of the metal nanowire dispersion medium may include water and alcohols. Specific examples of the alcohols may include methanol, ethanol, 1-propanol, 2-propanol, 1-butanol, 2-butanol, 2-methylpropanol, 1,1-dimethyl ethanol, and cyclohexanol. Among these, water, methanol, ethanol, 1-propanol, and 2-propanol are preferable, and water is further preferable. One of these may be used, or two or more thereof may be used in combination.

### [Others]

The metal nanowire-containing composition may include various additives within the range that does not impair the effects of the present invention. Examples of the additives may include a surfactant, a crosslinking agent, a pH preparation agent, an electrical conduction promoter, a thickening agent, an inorganic or organic fine particle, a flame retardant, a flame retardant auxiliary, an antioxidant, a leveling agent, a sliding activator, an antistatic agent, a dye, and a filler.

From the viewpoint of the electrical conductivity and transparency of a coating of the metal nanowire-containing composition, the ratio of the mass of the metal nanowire to the total mass of the compound (A), the compound (B), and the compound (C) in the metal nanowire-containing composition is preferably 1/100≤([compound (A)+compound (B)+compound (C)]/metal nanowire≤1/1, further preferably 1/50≤[compound (A)+compound (B)+compound (C)]/metal nanowire≤1/2.

### [Resin Composition for Coating Metal Nanowire-Containing Layers]

The resin composition for coating metal nanowire-containing layers is a composition which includes at least one of a photoinitiator and a thermal polymerization initiator, at least one of a polymerizable monomer and macromonomer, and a weather resistance improver, and further includes, appropriately as necessary, a solvent, a curing promoter, and other additives described later.

It is noted that the resin composition for coating metal nanowire-containing layers can be cured to obtain a predetermined molded product.

### [Photopolymerization Initiator]

The photopolymerization initiator is not particularly limited, and may be a photopolymerization initiator which is obtained by a known method or is commercially available. Specific examples of the photopolymerization initiator may include 1-hydroxycyclohexyl phenyl ketone, diethoxyacetophenone, 2-hydroxy-2-methyl-1-phenylpropane-1-one, 1-[4-(2-hydroxyethoxy)-phenyl]-2-hydroxy-2-methyl-1-propane-1-one, benzoin, benzoin methyl ether, benzoin ethyl ether, benzoylbenzoic acid, benzoylbenzoic acid methyl, 2-methyl-1-[4-(methylthio)phenyl]-2-(4-morpholinyl)-1-propanone, xanthone, anthraquinone, and 2-methylanthraquinone. Among these, 1-hydroxycyclohexyl phenyl ketone and 2-hydroxy-2-methyl-1-phenylpropane-1-one are preferable, and 1-hydroxycyclohexyl phenyl ketone is further preferable. One of these may be used, or two or more thereof may be used in combination.

### [Thermal Polymerization Initiator]

The thermal polymerization initiator is not particularly limited, and may be a thermal polymerization initiator which is obtained by a known method or is commercially available. Specific examples of the thermal polymerization initiator may include: persulfates such as ammonium persulfate, sodium persulfate, and potassium persulfate; peroxides such as t-butyl hydroperoxide, cumene hydroperoxide, benzoyl peroxide, and lauroyl peroxide; redox initiators by a combination of persulfates or peroxides and a reducing agent such as sulfite, bisulfite, thiosulfate, sodium formaldehyde sulphoxylate, ferrous sulfate, ammonium ferrous sulfate, glucose, and ascorbic acid; and azo compounds such as 2,2′-azobisisobutyronitrile, 2,2′-azobis(2,4-dimethylvaleronitrile), 2,2′-azobis(2-methylbutylonitrile), 2,2′-azobis(2-methylpropionic acid) dimethyl, and 2,2′-azobis(2-aminopropane) dihydrochloride. One of these may be used, or two or more thereof may be used in combination.

### [Polymerizable Monomer and Macromonomer]

The polymerizable monomer and macromonomer to be used are not particularly limited, as long as they are a monomer and macromonomer which cause polymerization reaction directly by visible light or irradiation with ionizing radiation such as UV rays and electron beams or by the effect of an initiator. Specific examples of the polymerizable monomer having one functional group in one molecule may include: (meth)acrylic acid esters such as (meth)acrylic acid, methyl (meth)acrylate, ethyl (meth)acrylate, butyl (meth)acrylate, 2-ethylhexyl (meth)acrylate, cyclohexyl (meth)acrylate, phenoxyethyl (meth)acrylate, 2-hydroxyethyl (meth)acrylate, methoxy-diethylene glycol (meth)acrylate, and methoxy-triethylene glycol (meth)acrylate; (meth)allyl compounds such as (meth)allyl alcohol and glycerol mono(meth)allyl ether; aromatic vinyls such as styrene, methylstyrene, and butylstyrene; carboxylic acid vinyl esters such as vinyl acetate; and (meth)acrylamide, N-cyclohexyl (meth)acrylamide, N-phenyl (meth)acrylamide, N-(2-hydroxyethyl) (meth)acrylamide, and (meth)acrylamides. Also, specific examples of the polymerizable monomer having two or more functional groups in one molecule may include: polyethylene glycol di(meth)acrylate, trimethylolpropane tri(meth)acrylate or ditrimethylolpropane tetra(meth)acrylate, pentaerythritol tri(meth)acrylate, pentaerythritol tetra(meth)acrylate, dipentaerythritol penta(meth)acrylate, dipentaerythritol hexa(meth)acrylate, alkyl-modified dipentaerythritol pentaerythritol, ethylene oxide-modified bisphenol A di(meth)acrylate, ethylene oxide-modified trimethylolpropane tri(meth)acrylate, propylene oxide-modified trimethylolpropane tri(meth)acrylate, and ethylene oxide-modified isocyanuric acid triacrylate. Specific examples of the macromonomer to be used may include polymerizable urethane acrylate resin, polymerizable polyurethane resin, polymerizable acrylic resin, polymerizable epoxy resin, and polymerizable polyester resin, which have one or more polymerizable unsaturated groups on average per molecule. Among these, trimethylolpropane tri(meth)acrylate, ditrimethylolpropane tetra(meth)acrylate, pentaerythritol tri(meth)acrylate, pentaerythritol tetra(meth)acrylate, dipentaerythritol penta(meth)acrylate, dipentaerythritol hexa(meth)acrylate, alkyl-modified dipentaerythritol pentaerythritol, polymerizable urethane acrylate resin, and polymerizable polyurethane resin are preferable, and trimethylolpropane tri(meth)acrylate and dipentaerythritol hexa(meth)acrylate are further preferable. One of these may be used, or two or more thereof may be used in combination.

### [Solvent]

The resin composition for coating metal nanowire-containing layers may further include a solvent. The solvent is not particularly limited, as long as it is a compound which allows for the dissolution of other components in the resin composition for coating metal nanowire-containing layers and evaporates during film formation to form a uniform coating. Specific examples of the solvent may include water, methanol, ethanol, 1-propanol, 2-propanol, acetone, methyl ethyl ketone, toluene, n-hexane, n-butyl alcohol, methyl isobutyl ketone, methyl butyl ketone, ethyl butyl ketone, cyclohexanone, ethyl acetate, butyl acetate, propylene glycol monomethyl ether acetate, ethylene glycol monoethyl ether, propylene glycol monomethyl ether, diethylene glycol diethyl ether, diethylene glycol ethyl methyl ether, 1,3-butylene glycol diacetate, cyclohexanol acetate, propylene glycol diacetate, tetrahydrofurfuryl alcohol, methyl ethyl diglycol, and N-methyl-2-pyrrolidone. Among these, 1-propanol, 2-propanol, toluene, methyl ethyl ketone, methyl isobutyl ketone, ethyl acetate, butyl acetate, propylene glycol monomethyl ether acetate, and propylene glycol monomethyl ether are preferable, and propylene glycol monomethyl ether is further preferable. One of these may be used, or two or more thereof may be used in combination.

### [Curing Promoter]

The resin composition for coating metal nanowire-containing layers may further include a curing promoter. The curing promoter is not particularly limited, as long as it is a compound which has two or more reactive functional groups in one molecule. Specific examples of the reactive functional group may include an isocyanate group, an acryl group, a methacryl group, and a mercapto group. One of these may be used, or two or more thereof may be used in combination.

### [Others]

The resin composition for coating metal nanowire-containing layers may include various additives within the range that does not impair the effects of the present invention. Examples of the additives may include an organic fine particle, a retardant, a retardant promoter, an antioxidant, a leveling agent, a sliding activator, an antistatic agent, a dye, and a filler.

In the present invention, the total content of the weather resistance improver in the resin composition for coating metal nanowire-containing layers, with respect to the nonvolatile content of the resin composition for coating metal nanowire-containing layers, is preferably 0.1% by mass or more and 15% by mass or less, further preferably 1% by mass or more and 5% by mass or less.

### [Film Formation]

As a coating method of the resin composition for coating metal nanowire-containing layers and the metal nanowire-containing composition, a known coating method can be used. Specific examples of the coating method may include a spin coating method, a slit coating method, a dip coating method, a blade coating method, a bar coating method, a spray method, a relief printing method, an intaglio printing method, a screen printing method, a lithographic printing method, a dispense method, and an inkjet method. Also, these coating methods may be used for multiple recoatings.

### [Laminating Method]

The manufacturing method of the metal nanowire-containing laminate is not particularly limited. Examples of the manufacturing method may include: forming a film of the metal nanowire-containing composition on a substrate to form a metal nanowire-containing layer, and further forming a film of the resin composition for coating metal nanowire-containing layers on the top surface of the metal nanowire-containing layer to form a protective layer of the metal nanowire-containing layer; and previously forming a protective layer on a substrate, and sequentially forming a metal nanowire-containing layer and a protective layer in this order on the protective layer.

The metal nanowire-containing composition can be diluted to an optional concentration for coating depending on a coating method. Examples of a dilution and dispersion medium may include water and alcohols. Specific examples of the alcohols may include methanol, ethanol, 1-propanol, 2-propanol, 1-butanol, 2-butanol, 2-methylpropanol, 1,1-dimethyl ethanol, and cyclohexanol. One of these may be used, or two or more thereof may be used in combination.

The resin composition for coating metal nanowire-containing layers can be diluted to an optional concentration for coating depending on a coating method. Specific examples of a dilution solvent may include water, methanol, ethanol, iso-propanol, acetone, methyl ethyl ketone, toluene, n-hexane, n-butyl alcohol, methyl isobutyl ketone, methyl butyl ketone, ethyl butyl ketone, cyclohexanone, ethyl acetate, butyl acetate, propylene glycol monomethyl ether acetate, ethylene glycol monoethyl ether, propylene glycol monomethyl ether, diethylene glycol diethyl ether, diethylene glycol ethyl methyl ether, 1,3-butylene glycol diacetate, cyclohexanol acetate, propylene glycol diacetate, tetrahydrofurfuryl alcohol, methyl ethyl diglycol, and N-methyl-2-pyrrolidone. One of these may be used, or two or more thereof may be used in combination.

Since the weather resistance improver according to the present invention can suppress the degradation of a transparent conductive film including metal nanowires both under long-term exposure to sunlight and under high humidity and high temperature conditions, it is widely applied for, for example, forming transparent conductive films of various devices, such as an electrode material for liquid crystal displays, an electrode material for plasma displays, an electrode material for organic electroluminescence displays, an electrode material for electronic papers, an electrode material for touch panels, an electrode material for thin film-type amorphous Si solar cells, an electrode material for dye-sensitized solar cells, an electromagnetic shielding material, and an antistatic material.

### EXAMPLES

Although the present invention will be specifically described below based on examples of the present invention, the present invention is not limited to these examples. Also, since silver is used as a metal species in the examples, the metal nanowire defined in the present invention was expediently read as a silver nanowire. It is noted that “parts” and “%” as described in Examples and Comparative Examples are based on mass, unless otherwise stated. In Examples and Comparative Examples, pure water was used as water that is a constituent component.

### [Diameter of Silver Nanowire]

Using a scanning electron microscope (SEM; JSM-5610LV manufactured by JEOL Ltd.), 100 silver nanowires were observed. From an arithmetic average value for the observed silver nanowires, the diameter of the silver nanowire was calculated.

### [Major Axis Length of Silver Nanowire]

Using a scanning electron microscope (SEM; JSM-5610LV manufactured by JEOL Ltd.), 100 silver nanowires were observed. From an arithmetic average value for the observed silver nanowires, the major axis length of the silver nanowire was calculated.

### [Average Surface Electrical Resistance Value of Silver Nanowire-Containing Laminate]

The surface electrical resistance value (Ω/ [symbol] ) was measured at 10 different sites on the silver nanowire-containing laminate. From an arithmetic average for the measured surface electrical resistance values, the average surface electrical resistance value of the silver nanowire-containing laminate was calculated. The surface electrical resistance value was measured using a non-contact type surface resistance measurement instrument EC-80P (manufactured by Napson Corporation).

### [Total Light Transmittance Change Amount of Substrate by Silver Nanowire-Containing Laminate]

The total light transmittance was measured for a substrate not having been subjected to any treatment and a substrate having the silver nanowire-containing laminate. From a difference between the measured total light transmittance values, the total light transmittance change amount of a substrate by the silver nanowire-containing laminate was calculated. The lower the value of the total light transmittance change amount is, the higher the transparency of the silver nanowire-containing laminate is. The measurement was performed using NDH5000 (Nippon Denshoku Industries Co., Ltd.).

### [Haze Change Amount of Substrate by Silver Nanowire-Containing Laminate]

The haze was measured for a substrate not having been subjected to any treatment and a substrate having the silver nanowire-containing laminate. From a difference between the measured haze values, the haze change amount of a substrate by the silver nanowire-containing laminate was calculated. The lower the value of the haze change amount is, the lower the turbidity of the silver nanowire-containing laminate is. The measurement was performed using NDH5000 (Nippon Denshoku Industries Co., Ltd.).

### [Light Stability of Silver Nanowire-Containing Laminate]

A separator on one surface of optical elastic resin (manufactured by 3M Japan Limited, trade name 8146-2, film thickness 50 μm) was peeled, and the optical clear adhesive was bonded onto the surface of the silver nanowire-containing laminate formed on a PET film. Furthermore, a separator on the other surface of the bonded optical elastic resin was peeled, and a glass substrate was bonded on the other surface of the optical elastic resin, thereby to prepare a laminate in which the silver nanowire-containing laminate, the optical elastic resin, and the glass were sequentially laminated on the PET film. A black tape (manufactured by Nichiban Co., Ltd., vinyl tape VT-50 black) was stuck on the glass surface side in such a manner as to cover a half of the entire surface of this laminate to prepare a sample for a light stability test.

The PET film surface of the prepared sample for a light stability test was measured for the surface electrical resistance value. The surface electrical resistance value was measured using a non-contact type surface resistance measurement instrument EC-80P (manufactured by Napson Corporation). The surface electrical resistance value was measure at three locations: an irradiation portion (a region on which the black tape was not stuck), a boundary portion (a boundary between a region on which the black tape was stuck and a region on which the black tape was not stuck), and a light blocked portion (a region on which the black tape was stuck). The measured surface electrical resistance values were each set as an initial value (Rp0) of the corresponding location.

Subsequently, the sample for a light stability test was irradiated by a xenon lamp with a light stability tester (manufactured by Atlas Material Technology, SUNTEST CPS+). The test conditions were: a daylight filter loaded, black panel temperature 70° C., irradiation intensity 750 W/m² (integrated value of spectral irradiance at a wavelength of 300 nm to 800 nm), temperature in a test tank 42° C., humidity 50 RH %, test time 500 hours. After the light stability test, the sample was left to stand at room temperature for one day. Then, the surface electrical resistance value was measured again at the irradiation portion, the boundary portion, and the light blocked portion. These surface electrical resistance values were set as a surface electrical resistance value (Rp1).

The light stability of the silver nano ire-containing laminate was evaluated as below based on the surface electrical resistance values Rp0 and Rp1 before and after the light stability test.

### AA; Rp1/Rp0≤1.1

### A; 1.1<Rp1/Rp0≤1.2

### BB; 1.2<Rp1/Rp0≤1.3

### B; 1.3<Rp1/Rp0≤1.5

### BC; 1.5<Rp1/Rp0≤2.0

### C; 2.0<Rp1/Rp0

It is noted that the order of superiority in light stability is as follows.

Light stability: AA (superior)→A→BB→B→BC→C (inferior)

### [High Temperature and High Humidity Stability of Silver Nanowire-Containing Laminate]

The silver nanowire-containing laminate was left to stand under the environment of 85° C. and 85 RH % for 240 hours using a constant temperature and humidity chamber tester (manufactured by Isuzu Seisakusho Co., Ltd., TPAV-48-20) for performing a high temperature and high humidity stability test. The surface electrical resistance value before a high temperature and high humidity stability test was measured, and this surface electrical resistance value was set as an initial value (Rw0). The surface electrical resistance value was measured using a non-contact type surface resistance measurement instrument EC-80P (manufactured by Napson Corporation). After the high temperature and high humidity stability test, the silver nanowire-containing laminate was left to stand at room temperature for one day. Then, the surface electrical resistance value was measured again. This surface electrical resistance value was set as a surface electrical resistance value (Rw1) after a high temperature and high humidity stability test.

The high temperature and high humidity stability of the silver nanowire-containing laminate was evaluated as below based on the surface electrical resistance values Rw0 and Rw1 before and after a high temperature and high humidity stability test.

### AA; Rw1/Rw0≤1.1

### A; 1.1<Rw1/Rw0≤1.2

### BB; 1.2<Rw1/Rw0≤1.3

### B; 1.3<Rw1/Rw0≤1.5

### C; 1.5<Rw1/Rw0≤2.0

### CC; 2.0<Rw1/Rw0

It is noted that the order of superiority in high temperature and high humidity stability is as follows.

High temperature and high humidity stability: AA (superior)→A→BB→B→C→CC (inferior)

### [Preparation of Silver Nanowire Dispersion]

While delivering nitrogen into a four-necked flask equipped with a stirrer, a thermometer, and a nitrogen introduction tube (hereinafter, a “four-necked flask equipped with a stirrer, a thermometer, and a nitrogen introduction tube” is abbreviated as a “four-necked flask”) under light shielding, 1.00 part by mass of an N-(2-hydroxyethyl) acrylamide polymer having a weight average molecular weight of 290,000 as a silver nanowire growth control agent and 117.9 parts by mass of 1,2-propanediol were added. The mixture was stirred at 120° C. for dissolution. Into the resultant solution, 9.0 parts by mass of 1,2-propanediol and 0.0054 part by mass of ammonium chloride were added. The mixture was increased in temperature to 140° C., and stirred for 15 minutes. Furthermore, 40.0 parts by mass of 1,2-propanediol and 0.85 part by mass of silver nitrate were added. The mixture was stirred at 140° C. for 45 minutes to prepare a silver nanowire. A large excess of pure water was added to the obtained silver nanowire dispersion, and the silver nanowire component was filtered off. Then, the residue was dispersed again in water as a silver nanowire dispersion medium. This operation was repeated multiple times thereby to purify a silver nanowire component. Thus, a silver nanowire dispersion having a silver nanowire content of 12.5% by mass was prepared. The obtained silver nanowire had an average major axis diameter of 14 μm and an average diameter of 41 nm.

[Preparation of Binder (a)]

Into a four-necked flask, 20 parts by mass of hydroxypropyl methyl cellulose (a product manufactured by Shin-Etsu Chemical Co., Ltd., product name Metolose 90SH 15000) and 950 parts by mass of pure water were charged. Thereafter, 0.3 part by mass of 5% by mass phosphoric acid was added. The mixture was increased in temperature to 50° C. Subsequently, 0.1 part by mass of N-methylol acrylamide was added, and the mixture was stirred for 6 hours. Furthermore, the temperature was increased to 70° C., and 15 parts by mass of methyl methacrylate, 5 parts by mass of n-butyl acrylate, and 8 parts by mass of a 1% by mass ammonium persulfate aqueous solution were added while allowing nitrogen gas to flow. The mixture was stirred for 3 hours to synthesize a 4.0% by mass binder (a) as a hydroxypropyl methyl cellulose dispersion obtained by graft polymerization of (meth)acrylic acid ester.

[Preparation of Binder (b)]

Into a four-necked flask, 106 parts by mass of dimethyl terephthalate, 78 parts by mass of dimethyl isophthalate, 18 parts by mass of sodium dimethyl 5-sulfoisophthalate, 124 parts by mass of ethylene glycol, and 0.8 part by mass of anhydrous sodium acetate were charged while allowing nitrogen gas to flow. Thereafter, the mixture was increased in temperature to 150° C. while stirring. The temperature was further increased to 180° C. while distilling generated methanol away from the reaction system. The product was stirred for 3 hours. Then, 0.2 part by mass of tetra-n-butyl titanate was added. The mixture was increased in temperature to 230° C. while stirring, and stirred under a reduced pressure of 10 hPa for 7 hours while distilling generated ethylene glycol away from the reaction system. Thereafter, the resultant product was cooled to 180° C. Then, 1 part by mass of trimellitic anhydride was added. The mixture was stirred for 3 hours, and thereafter cooled to room temperature. Thus, aqueous polyester resin (b-1) was synthesized. Into a four-necked flask, 200 parts by mass of the aqueous polyester resin (b-1) and 298 parts by mass of pure water were charged. Thereafter, the solution was increased in temperature to 60° C. while stirring, so that the aqueous polyester resin was dissolved. Then, 2.5 parts by mass of glycidyl methacrylate was added, and the mixture was stirred for 1 hour. Furthermore, 279 parts by mass of pure water was added. The solution was cooled to 40° C. while stirring. Then, 37.5 parts by mass of methyl methacrylate and 12.5 parts by mass of n-butyl acrylate were added, and the mixture was increased in temperature to 70° C. while stirring. Then, 4 parts by mass of 1% by mass ammonium persulfate was added while allowing nitrogen gas to flow, and the mixture was stirred for 4 hours. Thereafter, 167 parts of pure water was added to synthesize a binder (b) as an aqueous polyester resin dispersion obtained by graft polymerization of 10.0% by mass (meth)acrylic acid ester.

### [Preparation of Silver Nanowire-Containing Composition (1)]

Into a four-necked flask, 0.48 part by mass of a 12.5% by mass silver nanowire dispersion, 2.00 parts by mass of the binder (a) as a binder, and 97.52 parts by mass of pure water as a dispersion medium were charged. Thereafter, the mixture was stirred until a uniform dispersion was obtained. Thus, a silver nanowire-containing composition (1) was prepared.

### [Preparation of Silver Nanowire-Containing Composition (2)]

Into a four-necked flask, 0.48 part by mass of a 12.5% by mass silver nanowire dispersion, 2.00 parts by mass of the binder (a) as a binder, 0.006 part by mass of 3-(1,3-benzothiazole-2-ylthio)propionic acid (a product manufactured by Tokyo Chemical Industry Co., Ltd.) as a weather resistance improver, and 97.514 parts by mass of pure water as a dispersion medium were charged. Thereafter, the mixture was stirred until a uniform dispersion was obtained. Thus, a silver nanowire-containing composition (2) was prepared.

### [Preparation of Silver Nanowire-Containing Composition (3)]

Into a four-necked flask, 0.48 part by mass of a 12.5% by mass silver nanowire dispersion, 1.50 parts by mass of the binder (a) as a binder and 0.20 part by mass of the binder (b) as a binder, and 97.82 parts by mass of pure water as a dispersion medium were charged. Thereafter, the mixture was stirred until a uniform dispersion was obtained. Thus, a silver nanowire-containing composition (3) was prepared.

### [Preparation of Resin Composition for Coating Silver Nanowire-Containing Layers]

Into a four-necked flask, 15.00 parts by mass of dipentaerythritol hexaacrylate and 5.00 parts by mass of trimethylolpropane triacrylate as a polymerizable monomer and macromonomer, 0.80 part by mass of 1-hydroxycyclohexyl phenyl ketone as a polymerization initiator, 0.40 part by mass of 2-mercaptobenzothiazole (a product manufactured by Tokyo Chemical Industry Co., Ltd.) and 0.40 part by mass of gallic acid (a product manufactured by Tokyo Chemical Industry Co., Ltd.) as a weather resistance improver, and 80.00 parts by mass of propylene glycol monomethyl ether as a solvent were charged. Thereafter, the mixture was stirred until a uniform solution was obtained. Thus, a resin composition for coating silver nanowire-containing layers (1) was prepared.

Resin compositions for coating silver nanowire-containing layers (2) to (34) were obtained in a manner similar to the adjustment example of the resin composition for coating silver nanowire-containing layers (1), except that the weather resistance improver was as indicated in Table 1 and Table 2.

TABLE 1

| Resin composition for coating metal nanowire layers | | | (1) | (2) | (3) | (4) | (5) | (6) | (7) | (8) | (9) | (10) | (11) | (12) | (13) | (14) | (15) | (16) | (17) | (18) | (19) | (20) |
|---|---|---|---|---|---|---|---|---|---|---|---|---|---|---|---|---|---|---|---|---|---|---|
| Polymerixable monomer and | | Dipentearythritol | 15 | 15 | 15 | 15 | 15 | 15 | 15 | 15 | 15 | 15 | 15 | 15 | 15 | 15 | 15 | 15 | 15 | 15 | 15 | 15 |
| macromonomer | | hexacrylate | | | | | | | | | | | | | | | | | | | | |
| | | Trimethylolpropane | 5 | 5 | 5 | 5 | 5 | 5 | 5 | 5 | 5 | 5 | 5 | 5 | 5 | 5 | 5 | 5 | 5 | 5 | 5 | 5 |
| | | triacrylate | | | | | | | | | | | | | | | | | | | | |
| Polymerization | | 1-Hydroxycyclohexyl | 0.8 | 0.8 | 0.8 | 0.8 | 0.8 | 0.8 | 0.8 | 0.8 | 0.8 | 0.8 | 0.8 | 0.8 | 0.8 | 0.8 | 0.8 | 0.8 | 0.8 | 0.8 | 0.8 | 0.8 |
| initiator | | phenyl ketone | | | | | | | | | | | | | | | | | | | | |
| Weather | Compound | 2- | 0.4 | 0.05 | 1.4 | 0.02 | 0.024 | 2 | 1.92 | 0.4 | — | — | — | — | — | — | — | — | — | — | — | — |
| resistance improver | (A) | Mercaptobenzothiazole | | | | | | | | | | | | | | | | | | | | |
| | | 2- | — | — | — | — | — | — | — | — | — | — | — | — | — | — | — | — | — | — | — | — |
| | | Mercapto- | | | | | | | | | | | | | | | | | | | | |
| | | benzothiazole | | | | | | | | | | | | | | | | | | | | |
| | | methyl ether | | | | | | | | | | | | | | | | | | | | |
| | | 2- | — | — | — | — | — | — | — | — | 0.4 | — | — | 0.4 | 0.4 | 0.4 | 0.1 | 0.8 | 0.4 | 0.1 | 0.1 | 0.4 |
| | | Mercaptothiazoline | | | | | | | | | | | | | | | | | | | | |
| | | 3-(1,3-Benzo- | — | — | — | — | — | — | — | — | — | 0.4 | — | — | — | — | — | — | — | — | — | — |
| | | thiazole-2- | | | | | | | | | | | | | | | | | | | | |
| | | ylthio) | | | | | | | | | | | | | | | | | | | | |
| | | propionic | | | | | | | | | | | | | | | | | | | | |
| | | acid | | | | | | | | | | | | | | | | | | | | |
| | | (1,3-Benzo- | — | — | — | — | — | — | — | — | — | — | 0.4 | — | — | — | — | — | — | — | — | — |
| | | thiazole-2-ylthio) | | | | | | | | | | | | | | | | | | | | |
| | | succinic | | | | | | | | | | | | | | | | | | | | |
| | | acid | | | | | | | | | | | | | | | | | | | | |
| | Compound | Gallic acid | 0.4 | 0.05 | 1.4 | 2 | 1.92 | 0.02 | 0.024 | — | 0.4 | — | — | — | — | — | — | — | — | — | — | — |
| | (B) | Propyl | — | — | — | — | — | — | — | — | — | 0.4 | — | — | — | — | — | — | — | — | — | — |
| | | gallate | | | | | | | | | | | | | | | | | | | | |
| | | Octyl | — | — | — | — | — | — | — | — | — | | 0.4 | — | — | — | — | — | — | — | — | — |
| | | gallate | | | | | | | | | | | | | | | | | | | | |
| | | Tannic | — | — | — | — | — | — | — | — | — | — | — | — | — | 0.4 | 0.8 | 0.1 | — | — | — | 0.4 |
| | | acid | | | | | | | | | | | | | | | | | | | | |
| | Compound | (Z)-2-(2- | — | — | — | — | — | — | — | 0.4 | — | — | — | 0.4 | — | — | — | — | — | — | — | — |
| | (C) | Amino- | | | | | | | | | | | | | | | | | | | | |
| | | 4-thiazolyl)- | | | | | | | | | | | | | | | | | | | | |
| | | 2- | | | | | | | | | | | | | | | | | | | | |
| | | methoxy-imino) | | | | | | | | | | | | | | | | | | | | |
| | | acetic acid | | | | | | | | | | | | | | | | | | | | |
| | | ethyl ester | | | | | | | | | | | | | | | | | | | | |
| | | (Z)-t-Butyl | — | — | — | — | — | — | — | — | — | — | — | — | 0.4 | — | — | — | — | — | — | — |
| | | 2-(([1-(2- | | | | | | | | | | | | | | | | | | | | |
| | | amino- | | | | | | | | | | | | | | | | | | | | |
| | | thiazole)- | | | | | | | | | | | | | | | | | | | | |
| | | 4-yl)-2- | | | | | | | | | | | | | | | | | | | | |
| | | (benzo[d] | | | | | | | | | | | | | | | | | | | | |
| | | thiazole-2- | | | | | | | | | | | | | | | | | | | | |
| | | ylthio)- | | | | | | | | | | | | | | | | | | | | |
| | | 2-oxoethyl- | | | | | | | | | | | | | | | | | | | | |
| | | idene] | | | | | | | | | | | | | | | | | | | | |
| | | amino]oxy)- | | | | | | | | | | | | | | | | | | | | |
| | | 2- | | | | | | | | | | | | | | | | | | | | |
| | | methyl- | | | | | | | | | | | | | | | | | | | | |
| | | propanoate | | | | | | | | | | | | | | | | | | | | |
| | | (Z)-2-(2- | — | — | — | — | — | — | — | — | — | — | — | — | — | — | — | — | 0.4 | 0.2 | 0.8 | 0.1 |
| | | Amino- | | | | | | | | | | | | | | | | | | | | |
| | | 4-thiazolyl)- | | | | | | | | | | | | | | | | | | | | |
| | | 2- | | | | | | | | | | | | | | | | | | | | |
| | | (methoxy- | | | | | | | | | | | | | | | | | | | | |
| | | imino) | | | | | | | | | | | | | | | | | | | | |
| | | thioacetic | | | | | | | | | | | | | | | | | | | | |
| | | acid | | | | | | | | | | | | | | | | | | | | |
| | | S-(2-benzothiazolyl) | | | | | | | | | | | | | | | | | | | | |
| Solvent | | Propylene glycol | 80 | 80 | 80 | 80 | 80 | 80 | 80 | 80 | 80 | 80 | 80 | 80 | 80 | 80 | 80 | 80 | 80 | 80 | 80 | 80 |
| | | monomethyl ether | | | | | | | | | | | | | | | | | | | | |

TABLE 2

| Resin composition for coating | | | | | | | | | | | | | | | |
|---|---|---|---|---|---|---|---|---|---|---|---|---|---|---|---|
| metal nanowire layers | | (21) | (22) | (23) | (24) | (25) | (26) | (27) | (28) | (29) | (30) | (31) | (32) | (33) | (34) |
| Polymerixable | Dipentearythritol | 15 | 15 | 15 | 15 | 15 | 15 | 15 | 15 | 15 | 15 | 15 | 15 | 15 | 15 |
| monomer | hexacrylate | | | | | | | | | | | | | | |
| and | Trimethylolpropane | 5 | 5 | 5 | 5 | 5 | 5 | 5 | 5 | 5 | 5 | 5 | 5 | 5 | 5 |
| macromonomer | triacrylate | | | | | | | | | | | | | | |
| Polymerization | 1-Hydroxy- | 0.8 | 0.8 | 0.8 | 0.8 | 0.8 | 0.8 | 0.8 | 0.8 | 0.8 | 0.8 | 0.8 | 0.8 | 0.8 | 0.8 |
| initiator | cyclohexyl | | | | | | | | | | | | | | |
| | phenyl ketone | | | | | | | | | | | | | | |
| Weather | Compound | — | 0.4 | — | — | — | — | — | — | — | — | — | — | — | — |
| resistance | (A) 2- | | | | | | | | | | | | | | |
| improver | Mercapto- | | | | | | | | | | | | | | |
| | benzothiazole | | | | | | | | | | | | | | |
| | Compound | — | — | 0.4 | — | — | — | — | — | — | — | — | — | — | — |
| | (B) | | | | | | | | | | | | | | |
| | Gallic acid | | | | | | | | | | | | | | |
| | Compound | — | — | — | 0.4 | — | — | — | — | — | — | — | — | — | — |
| | (C) | | | | | | | | | | | | | | |
| | (Z)-2-(2-Amino- | | | | | | | | | | | | | | |
| | 4-thiazolyl)-2- | | | | | | | | | | | | | | |
| | methoxyimino) | | | | | | | | | | | | | | |
| | acetic acid | | | | | | | | | | | | | | |
| | ethyl ester | | | | | | | | | | | | | | |
| | 5- | — | — | — | — | 0.4 | — | — | — | — | — | — | — | — | — |
| | Mercapto- | | | | | | | | | | | | | | |
| | 1-phenyl- | | | | | | | | | | | | | | |
| | 1H-tetrazole | | | | | | | | | | | | | | |
| | Tris(2,4- | — | — | — | — | — | 0.4 | — | — | — | — | — | — | — | — |
| | pentanedionate) | | | | | | | | | | | | | | |
| | aluminum (III) | | | | | | | | | | | | | | |
| | 4-[[4,6-Bis | — | — | — | — | — | — | 0.4 | — | — | — | — | — | — | — |
| | (octylthio)- | | | | | | | | | | | | | | |
| | 1,3,5-triazine-2- | | | | | | | | | | | | | | |
| | yl]amino]2,6-di- | | | | | | | | | | | | | | |
| | tert-butylphenol | | | | | | | | | | | | | | |
| | 2-(2′-Hydroxy- | — | — | — | — | — | — | — | 0.4 | — | — | — | — | — | — |
| | 5′-methyl- | | | | | | | | | | | | | | |
| | phenyl)benzo- | | | | | | | | | | | | | | |
| | triazole | | | | | | | | | | | | | | |
| | Didodecyl | — | — | — | — | — | — | — | — | 0.4 | — | — | — | — | — |
| | 3,3′-thiodi- | | | | | | | | | | | | | | |
| | propionate | | | | | | | | | | | | | | |
| | 1,2,2,6,6- | — | — | — | — | — | — | — | — | — | 0.4 | — | — | — | — |
| | Pentamethyl-4- | | | | | | | | | | | | | | |
| | piperidyl | | | | | | | | | | | | | | |
| | methacrylate | | | | | | | | | | | | | | |
| | Triphenyl- | — | — | — | — | — | — | — | — | — | — | 0.4 | — | — | — |
| | phosphine | | | | | | | | | | | | | | |
| | Dibutyl | — | — | — | — | — | — | — | — | — | — | — | 0.4 | — | — |
| | hydroxytoluene | | | | | | | | | | | | | | |
| | α-Terpineol | — | — | — | — | — | — | — | — | — | — | — | — | 0.4 | — |
| | D-Penicillamine | — | — | — | — | — | — | — | — | — | — | — | — | — | 0.4 |
| Solvent | Propylene glycol | 80 | 80 | 80 | 80 | 80 | 80 | 80 | 80 | 80 | 80 | 80 | 80 | 80 | 80 |
| | monomethyl | | | | | | | | | | | | | | |
| | ether | | | | | | | | | | | | | | |

It is noted that as the weather resistance improvers in Table 1 and Table 2, the following weather resistance improvers were used.

2-mercaptobenzothiazole: a product manufactured by Tokyo Chemical Industry Co., Ltd.
2-mercaptobenzothiazole methyl ether: a product manufactured by Tokyo Chemical Industry Co., Ltd.
2-mercaptothiazoline: a product manufactured by Tokyo Chemical Industry Co., Ltd.
3-(1,3-benzothiazole-2-ylthio)propionic acid: a product manufactured by Tokyo Chemical Industry Co., Ltd.
(1,3-benzothiazole-2-ylthio)succinic acid: a product manufactured by Hammond Group, Inc. (product name Halox Flash-X 350D)
gallic acid: a product manufactured by Tokyo Chemical Industry Co., Ltd.
propyl gallate: a product manufactured by Tokyo Chemical Industry Co., Ltd.
octyl gallate: a product manufactured by Tokyo Chemical Industry Co., Ltd.
tannic acid: a product manufactured by Kanto Chemical Co., Inc.
(Z)-2-(2-amino-4-thiazolyl)-2-(methoxyimino)acetic acid ethyl ester: a product manufactured by Tokyo Chemical Industry Co., Ltd.
(Z)-t-butyl 2-({[1-(2-aminothiazole-4-yl)-2-(benzo[d]thiazole-2-ylthio)-2-oxoethylidene]amino}oxy)-2-methylpropanoate: a product manufactured by Ark Pharm, Inc.
(Z)-2-(2-amino-4-thiazolyl)-2-(methoxyimino)thioacetic acid S-(2-benzothiazolyl): a product manufactured by Tokyo Chemical Industry Co., Ltd.
5-mercapto-1-phenyl-1H-tetrazole: a product manufactured by Tokyo Chemical Industry Co., Ltd.
tris(2,4-pentanedionate)aluminum (III): a product manufactured by Tokyo Chemical Industry Co., Ltd.
4-[[4,6-bis(octylthio)-1,3,5-triazine-2-yl]amino]-2,6-di-tert-butylphenol: a product manufactured by BASF Japan Ltd. (product name Irganox 565)
2-(2-hydroxy-5-methyl phenyl)benzotriazole: a product manufactured by BASF Japan Ltd. (product name TINUVIN P)
didodecyl 3,3′-thiodipropionate: a product manufactured by Mitsubishi Chemical Corporation (product name DLTP “Yoshitomi”)
1,2,2,6,6-penta methyl-4-piperidyl methacrylate: a product manufactured by ADEKA Corporation (product name ADEKA STAB LA-82)
triphenylphosphine: a product manufactured by Tokyo Chemical Industry Co., Ltd.
dibutylhydroxytoluene: a product manufactured by Tokyo Chemical Industry Co., Ltd.
α-terpineol: a product manufactured by Tokyo Chemical Industry Co., Ltd.
D-penicillamine: a product manufactured by Tokyo Chemical Industry Co., Ltd.

### [Preparation of Silver Nanowire-Containing Layer (1)]

The silver nanowire-containing composition (1) was uniformly applied onto a polyethylene terephthalate film having a film thickness of 100 μm (PET film, manufactured by Toray Industries, Inc., trade name “Lumirror U403”) with 24 g/m². The coat was dried with a hot air convection dryer at 120° C. for 1 minute to prepare a silver nanowire-containing layer (1).

### [Preparation of Silver Nanowire-Containing Layer (2)]

The silver nanowire-containing composition (2) was uniformly applied onto a polyethylene terephthalate film having a film thickness of 100 μm (PET film, manufactured by Toray Industries, Inc., trade name “Lumirror U403”) with 24 g/m². The coat was dried with a hot air convection dryer at 120° C. for 1 minute to prepare a silver nanowire-containing layer (2).

### [Preparation of Silver Nanowire-Containing Layer (3)]

The silver nanowire-containing composition (3) was uniformly applied onto a polyethylene terephthalate film having a film thickness of 100 μm (PET film, manufactured by Toray Industries, Inc., trade name “Lumirror U403”) with 24 g/m². The coat was dried with a hot air convection dryer at 120° C. for 1 minute to prepare a silver nanowire-containing layer (3).

### [Preparation of Silver Nanowire-Containing Layer (4)]

The resin composition for coating silver nanowire-containing layers (12) was diluted by a factor of 40 with propylene glycol monomethyl ether. This diluted solution was uniformly applied onto a polyethylene terephthalate film having a film thickness of 100 μm (PET film, manufactured by Toray Industries, Inc., trade name “Lumirror U403”) with 24 g/m². The coat was dried with a hot air convection dryer at 120° C. for 5 minute. Thereafter, the PET substrate was irradiated with UV light downward from a UV irradiation device UV1501C-SZ (manufactured by SEN ENGINEERING CO., LTD) under the conditions of 500 mJ/cm² to form a protective layer of a silver nanowire layer. This protective layer was uniformly coated with the silver nanowire-containing composition (1) with 24 g/m. The coat was dried with a hot air convection dryer at 120° C. for 1 minute to prepare a silver nanowire-containing layer (4).

### Example 1

### <Preparation of Silver Nanowire-Containing Laminate (1)>

The resin composition for coating silver nanowire-containing layers (1) was diluted by a factor of 40 with propylene glycol monomethyl ether. The diluted solution was uniformly applied onto the silver nanowire-containing layer (1) with 24 g/m², and dried with a hot air convection dryer at 120° C. for 5 minute. Thereafter, the PET substrate was irradiated with UV light downward from a UV irradiation device UV1501C-SZ (manufactured by Cell Engineering Corporation) under the conditions of 500 mJ/cm² to prepare a silver nanowire-containing laminate (1). The constituent components and evaluation result of the silver nanowire-containing laminate according to Example 1 are indicated in Table 3.

### Examples 2 to 21

Silver nanowire-containing laminates (2) to (23) were prepared in a manner similar to the preparation example of the silver nanowire-containing laminate (1), except that the resin composition for coating silver nanowire-containing layers and the metal nanowire-containing layer were as indicated in Table 3 and Table 4 below. The constituent components and evaluation result of each of the silver nanowire-containing laminates according to Examples 2 to 21 are indicated in Table 3 and Table 4.

TABLE 3

| | | | Example | Example | Example | Example | Example | Example | Example | Example | Example | Example | Example | Example | Example |
|---|---|---|---|---|---|---|---|---|---|---|---|---|---|---|---|
| Items | | | 1 | 2 | 3 | 4 | 5 | 6 | 7 | 8 | 9 | 10 | 11 | 12 | 13 |
| Metal nanowire laminate | | | (1) | (2) | (3) | (4) | (5) | (6) | (7) | (8) | (9) | (10) | (11) | (12) | (13) |
| Resin composition for coating metal nanowire layers | | | (1) | (2) | (3) | (4) | (5) | (6) | (7) | (8) | (9) | (10) | (11) | (12) | (13) |
| Metal nanowire-containing layer | | | (1) | (1) | (1) | (1) | (1) | (1) | (1) | (1) | (1) | (1) | (1) | (1) | (1) |
| Configuration of metal | PET/metal nanowire-containing | | A | A | A | A | A | A | A | A | A | A | A | A | A |
| nanowire-containing | layer/protective layer | | | | | | | | | | | | | | |
| laminate | PET/protective layer/metal | | — | — | — | — | — | — | — | — | — | — | — | — | — |
| | nanowire-containing layer/protective layer | | | | | | | | | | | | | | |
| Evaluation result | Light stability | Irradiation | A | BB | BB | A | A | A | A | A | AA | AA | AA | AA | AA |
| | | portion | | | | | | | | | | | | | |
| | | Boundary | BB | BB | BB | BB | BB | BB | BB | BB | A | A | A | A | A |
| | | portion | | | | | | | | | | | | | |
| | | Light | A | A | A | A | A | A | A | A | AA | AA | AA | AA | AA |
| | | blocked | | | | | | | | | | | | | |
| | | portion | | | | | | | | | | | | | |
| | High temperature and | | A | BB | BB | BB | A | BB | A | A | A | A | A | A | A |
| | high humidity stability | | | | | | | | | | | | | | |
| Composition ratio | Mass ratio of | Compound (A)/ | 1/1 | 1/1 | 1/1 | 1/100 | 1/80 | 100/1 | 80/1 | 1/1 | 1/1 | 1/1 | 1/1 | 1/1 | 1/1 |
| | weather | [Compound (B) + | | | | | | | | | | | | | |
| | resistance | Compound (C)] | | | | | | | | | | | | | |
| | improver | | | | | | | | | | | | | | |
| | Concentration | [Compound (A) + | 3.8 | 0.5 | 13.5 | 9.7 | 9.3 | 9.7 | 9.3 | 3.8 | 3.8 | 3.8 | 3.8 | 3.8 | 3.8 |
| | (mass %) | Compound (B) + | | | | | | | | | | | | | |
| | of weather | Compound (C)]/ | | | | | | | | | | | | | |
| | resistance | mass of protective layer | | | | | | | | | | | | | |
| | improver | | | | | | | | | | | | | | |
| | to nonvolatile | | | | | | | | | | | | | | |
| | content of resin | | | | | | | | | | | | | | |
| | composition for | | | | | | | | | | | | | | |
| | coating metal | | | | | | | | | | | | | | |
| | nanowire layers | | | | | | | | | | | | | | |
| | Mass ratio of weather | [Compound (A) + | — | — | — | — | — | — | — | — | — | — | — | — | — |
| | resistance improver | Compound (B) + | | | | | | | | | | | | | |
| | to silver nanowire, in metal | Compound (C)]/metal nanowire | | | | | | | | | | | | | |
| | nanowire-containing | | | | | | | | | | | | | | |
| | composition | | | | | | | | | | | | | | |

TABLE 4

| | | | Example | Example | Example | Example | Example | Example | Example | Example | Example | Example |
|---|---|---|---|---|---|---|---|---|---|---|---|---|
| Items | | | 14 | 15 | 16 | 17 | 18 | 19 | 20 | 21 | 22 | 23 |
| Metal nanowire laminate | | | (14) | (15) | (16) | (17) | (18) | (19) | (29) | (21) | (22) | (23) |
| Resin composition for coating | | | (14) | (15) | (16) | (17) | (18) | (19) | (20) | (14) | (14) | (14) |
| metal nanowire layers | | | | | | | | | | | | |
| Metal nanowire-containing layer | | | (1) | (1) | (1) | (1) | (1) | (1) | (1) | (2) | (3) | (4) |
| Configuration | PET/metal | | A | A | A | A | A | A | A | A | A | — |
| of metal | nanowire-containing | | | | | | | | | | | |
| nanowire- | layer/protective layer | | | | | | | | | | | |
| containing | PET/protective layer/metal | | — | — | — | — | — | — | — | — | — | A |
| laminate | nanowire-containing layer/ | | | | | | | | | | | |
| | protective layer | | | | | | | | | | | |
| Evaluation | Light stability | Irradiation | AA | AA | AA | AA | AA | AA | AA | AA | AA | AA |
| result | | portion | | | | | | | | | | |
| | | Boundary | AA | AA | AA | AA | AA | AA | AA | AA | AA | AA |
| | | portion | | | | | | | | | | |
| | | Light | AA | AA | AA | AA | AA | AA | AA | AA | AA | AA |
| | | blocked | | | | | | | | | | |
| | | portion | | | | | | | | | | |
| | High temperature and | | A | A | A | A | A | A | A | AA | AA | AA |
| | high humidity stability | | | | | | | | | | | |
| Composition | Mass ratio of | Compound | 1/1 | 1/8 | 8/1 | 1/1 | 1/1 | 1/8 | 1/1.25 | 1/1 | 1/1 | 1/1 |
| ratio | weather | (A)/ | | | | | | | | | | |
| | resistance | [Compound | | | | | | | | | | |
| | improver | (B) + | | | | | | | | | | |
| | | Compound | | | | | | | | | | |
| | | (C)] | | | | | | | | | | |
| | Concentration | [Compound | 3.8 | 4.3 | 4.3 | 3.8 | 1.4 | 4.3 | 4.3 | 3.8 | 3.8 | 3.8 |
| | (mass %) | (A) + | | | | | | | | | | |
| | of weather | Compound | | | | | | | | | | |
| | resistance | (B) + | | | | | | | | | | |
| | improver | Compound | | | | | | | | | | |
| | to nonvolatile | (C)]/mass | | | | | | | | | | |
| | content of resin | of | | | | | | | | | | |
| | composition for | protective | | | | | | | | | | |
| | coating metal | layer | | | | | | | | | | |
| | nanowire layers | | | | | | | | | | | |
| | Mass ratio of | [Compound | — | — | — | — | — | — | — | — | — | — |
| | weather | (A) + | | | | | | | | | | |
| | resistance | Compound | | | | | | | | | | |
| | improver | (B) + | | | | | | | | | | |
| | to silver | Compound | | | | | | | | | | |
| | nanowire, | (C)]/metal | | | | | | | | | | |
| | in metal | nanowire | | | | | | | | | | |
| | nanowire- | | | | | | | | | | | |
| | containing | | | | | | | | | | | |
| | composition | | | | | | | | | | | |

### Comparative Examples 1 to 14

Silver nanowire-containing laminates (24) to (37) were obtained in a manner similar to the preparation example of the silver nanowire-containing laminate (1), except that the resin composition for coating silver nanowire-containing layers was as indicated in Table 5. The constituent components and evaluation result of each of the silver nanowire-containing laminates according to Comparative Examples 1 to 14 are indicated in Table 5.

TABLE 5

| | | | Com- | Com- | Com- | Com- | Com- | Com- | Com- |
|---|---|---|---|---|---|---|---|---|---|
| | | | par- | par- | par- | par- | par- | par- | par- |
| | | | ative | ative | ative | ative | ative | ative | ative |
| | | | Exam- | Exam- | Exam- | Exam- | Exam- | Exam- | Exam- |
| | | | ple | ple | ple | ple | ple | ple | ple |
| Items | | | 1 | 2 | 3 | 4 | 5 | 6 | 7 |
| Metal nanowire | | | (24) | (25) | (26) | (27) | (28) | (29) | (30) |
| laminate | | | | | | | | | |
| Resin composition | | | (21) | (22) | (23) | (24) | (25) | (26) | (27) |
| for coating | | | | | | | | | |
| metal nanowire | | | | | | | | | |
| layers | | | | | | | | | |
| Metal nanowire- | | | (1) | (1) | (1) | (1) | (1) | (1) | (1) |
| containing layer | | | | | | | | | |
| Configuration | PET/metal | | A | A | A | A | A | A | A |
| of | nanowire- | | | | | | | | |
| metal | containing | | | | | | | | |
| nanowire- | layer/ | | | | | | | | |
| containing | protective | | | | | | | | |
| laminate | layer | | | | | | | | |
| | PET/ | | — | — | — | — | — | — | — |
| | protective | | | | | | | | |
| | layer/metal | | | | | | | | |
| | nanowire- | | | | | | | | |
| | containing | | | | | | | | |
| | layer/ | | | | | | | | |
| | protective | | | | | | | | |
| | layer | | | | | | | | |
| Evaluation | Light | Irradiation | A | A | A | A | AA | A | AA |
| result | stability | portion | | | | | | | |
| | | Boundary | C | C | C | C | B | C | C |
| | | portion | | | | | | | |
| | | Light | A | A | A | A | A | A | AA |
| | | blocked | | | | | | | |
| | | portion | | | | | | | |
| | High | | C | A | C | C | C | C | C |
| | temperature and | | | | | | | | |
| | high humidity | | | | | | | | |
| | stability | | | | | | | | |
| | | | Com- | Com- | Com- | Com- | Com- | Com- | Com- |
| | | | par- | par- | par- | par- | par- | par- | par- |
| | | | ative | ative | ative | ative | ative | ative | ative |
| | | | Exam- | Exam- | Exam- | Exam- | Exam- | Exam- | Exam- |
| | | | ple | ple | ple | ple | ple | ple | ple |
| Items | | | 8 | 9 | 10 | 11 | 12 | 13 | 14 |
| Metal nanowire | | | (31) | (32) | (33) | (34) | (35) | (36) | (37) |
| laminate | | | | | | | | | |
| Resin composition | | | (28) | (29) | (30) | (31) | (32) | (33) | (34) |
| for coating | | | | | | | | | |
| metal nanowire | | | | | | | | | |
| layers | | | | | | | | | |
| Metal nanowire- | | | (1) | (1) | (1) | (1) | (1) | (1) | (1) |
| containing layer | | | | | | | | | |
| Configuration | PET/metal | | A | A | A | A | A | A | A |
| of | nanowire- | | | | | | | | |
| metal | containing | | | | | | | | |
| nanowire- | layer/ | | | | | | | | |
| containing | protective | | | | | | | | |
| laminate | layer | | | | | | | | |
| | PET/ | | — | — | — | — | — | — | — |
| | protective | | | | | | | | |
| | layer/metal | | | | | | | | |
| | nanowire- | | | | | | | | |
| | containing | | | | | | | | |
| | layer/ | | | | | | | | |
| | protective | | | | | | | | |
| | layer | | | | | | | | |
| Evaluation | Light | Irradiation | A | A | A | B | A | A | C |
| result | stability | portion | | | | | | | |
| | | Boundary | C | C | C | C | C | C | C |
| | | portion | | | | | | | |
| | | Light | A | A | A | B | A | AA | B |
| | | blocked | | | | | | | |
| | | portion | | | | | | | |

| | | | | | | | |
|---|---|---|---|---|---|---|---|
| High | C | C | C | C | C | C | C |
| temperature and | | | | | | | |
| high humidity | | | | | | | |
| stability | | | | | | | |

The average surface electrical resistance values of the obtained silver nanowire-containing laminates were all 60Ω/ [symbol] or less, indicating the achievement of a favorable average surface electrical resistance value.

The total light transmittance change amounts of substrates by the obtained silver nanowire-containing laminates were all 1% or less, indicating the achievement of high transparency.

The haze change amounts of substrates by the obtained silver nanowire-containing laminates were all 1% or less, indicating the achievement of low turbidity.

It is understood that Comparative Examples 1 and 5 to 14 do not include any of the compound (A), the compound (B), and the compound (C) as a weather resistance improver, with the result that the light stability and the high temperature and high humidity stability of the silver nanowire-containing laminate are low compared to Example 1.

It is understood that Comparative Example 2 does not include the compound (B) and the compound (C) as a weather resistance improver, with the result that the light stability of the silver nanowire-containing laminate is low compared to Example 1.

It is understood that Comparative Examples 3 and 4 do not include the compound (A) as a weather resistance improver, with the result that the light stability and the high temperature and high humidity stability of the silver nanowire-containing laminate are low compared to Example 1.

In Example 1, it is understood that the total content of the weather resistance improver in the resin composition for coating metal nanowire-containing layers, with respect to the nonvolatile content of the resin composition for coating metal nanowire-containing layers, is 1% by mass or more and 5% by mass or less, with the result that the light stability and the high temperature and high humidity stability of the silver nanowire-containing laminate are high compared to Examples 2 and 3 which are outside the range.

In Examples 1, 5, 7, and 8, it is understood that the ratio of the mass of the compound (A) to the total mass of the compound (B) and the compound (C) is 1/80≤compound (A)/[compound (B)+compound (C)]≤80/1, with the result that the high temperature and high humidity stability of the silver nanowire-containing laminate is high compared to Examples 4 and 6.

It is understood that Examples 9 to 13 include 3-(2-benzothiazole-2-ylthio)propionic acid and (1,3-benzothiazole-2-ylthio)succinic acid as the compound (A), with the result that the light stability of the silver nanowire-containing laminate is high compared to Example 1.

It is understood that Examples 14 to 16 include tannic acid as the compound (B), with the result that the light stability of the silver nanowire-containing laminate is high compared to Examples 9 to 13.

It is understood that Examples 17 to 19 include (Z)-2-(2-amino-4-thiazolyl)-2-(methoxyimino)thioacetic acid S-(2-benzothiazolyl) as the compound (C), with the result that the light stability of the silver nanowire-containing laminate is high compared to Examples 9 to 13.

It is understood that Example 20 includes tannic acid as the compound (B) and (Z)-2-(2-amino-4-thiazolyl)-2-(methoxyimino)thioacetic acid S-(2-benzothiazolyl) as the compound (C), with the result that the silver nanowire-containing laminate exhibits high light stability similarly to Examples 14 to 19.

It is understood that the silver nanowire-containing layer of Example 21 includes the compound (A) as a weather resistance improver, with the result that the high temperature and high humidity stability of the silver nanowire-containing laminate is high compared to Example 14.

It is understood that Example 22 includes polyester resin in the silver nanowire-containing layer, with the result that the high temperature and high humidity stability of the silver nanowire-containing laminate is high compared to Example 14.

It is understood that in Example 23, a protective layer formed with the resin composition for coating silver nanowire-containing layers is laminated on both surfaces of the silver nanowire-containing layer, with the result that the high temperature and high humidity stability of the silver nanowire-containing laminate is high compared to Example 14.

### DESCRIPTION OF REFERENCE SIGNS

1 Substrate
2 Metal nanowire-containing layer
3 Protective layer

1. A weather resistance improver comprising a compound (A) and at least one of a compound (B) and a compound (C):
compound (A): a compound represented by general formula (1) or (2) below general formula (1) 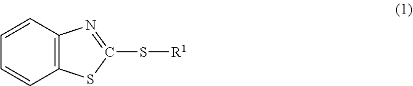
in general formula (1), R¹ represents a hydrogen atom, an alkyl group of 1 to 12 carbon atoms, or a (di)carboxyalkyl group having an alkyl group of 1 to 3 carbon atoms, general formula (2) 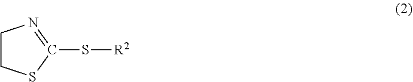
in general formula (2), R² represents a hydrogen atom, an alkyl group of 1 to 12 carbon atoms, or a (di)carboxyalkyl group having an alkyl group of 1 to 3 carbon atoms,
compound (B): gallic acid, a gallic acid derivative, or tannic acid
compound (C): a compound represented by general formula (3) below general formula (3) 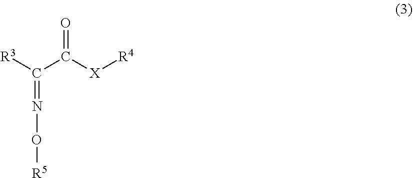
in general formula (3), X represents an oxygen atom or a sulfur atom, R³ represents a hydrogen atom, an acetyl group, a pyrazole group, or an aminothiazolyl group, R⁴ represents an alkyl group of 1 to 4 carbon atoms, or a benzothiazolyl group, and R⁵ represents an alkyl group of 1 to 4 carbon atoms, or an isobutyric acid alkyl ester group having an alkyl group of 1 to 4 carbon atoms.

2. The weather resistance improver according to claim 1, wherein
a ratio of a mass of the compound (A) to a total mass of the compound (B) and the compound (C) is 1/80≤compound (A)/[compound (B)+compound (C)]≤80/1.

3. The weather resistance improver according to claim 1, which is used for a metal nanowire.

4. The weather resistance improver according to claim 3, wherein
the metal nanowire is a silver nanowire.

5. The weather resistance improver according to claim 1, wherein
the compound (A) is at least one selected from 2-mercaptothiazoline, 3-(2-benzothiazole-2-ylthio)propionic acid, and (1,3-benzothiazole-2-ylthio)succinic acid.

6. The weather resistance improver according to claim 1, wherein
the compound (B) is tannic acid.

7. The weather resistance improver according to claim 1, wherein
the compound (C) is (Z)-2-(2-amino-4-thiazolyl)-2-(methoxyimino)thioacetic acid S-(2-benzothiazolyl).

8. A resin composition for coating metal nanowire-containing layers, comprising the weather resistance improver according to claim 3, at least one of a photopolymerization initiator and a thermal polymerization initiator, and at least one of a polymerizable monomer and macromonomer.

9. A metal nanowire-containing laminate comprising a metal nanowire-containing layer, and a protective layer for protecting the metal nanowire-containing layer disposed on the metal nanowire-containing layer, wherein the protective layer is a cured product of the resin composition for coating metal nanowire-containing layers according to claim 8.

10. The metal nanowire-containing laminate comprising a metal nanowire-containing layer, and a protective layer for protecting the metal nanowire-containing layer disposed on the metal nanowire-containing layer, wherein
the metal nanowire-containing layer includes the weather resistance improver according to claim 1.

11. The metal nanowire-containing laminate according to claim 9, wherein
the metal nanowire-containing layer includes aqueous polyester resin.
